(19) United States
(12) Patent Application Publication
(10) Pub. No.: US 2002/0108663 A1
(43) Pub. Date: Aug. 15, 2002

(54) Heat protective cover system for hot water pipes

(76) Inventor: Gabriel V. Lechuga, Rancho Mirage, CA (US)

Correspondence Address: ROBERT J. SCHAAP, Suite 188, 21241 Ventura Boulevard, Woodland Hills, CA, 91364, US

(21) Appl. No.: 09/735,342

(22) Filed: Dec. 12, 2000

(51) Int. Cl. F16L 9/14

(52) U.S. Cl. 138/158; 138/159; 138/167

(57) ABSTRACT

A heat protective cover system for hot water pipes which provide insulation precluding the possibility of burns or abrasions arising from contact with a hot water pipe by an unambulatory person who is wheelchair bound. The heat protective cover system of the present invention is a total access system, in that the heat protective covers or jackets which form part of the system can be secured to hot water pipes in such manner that they are relatively tamper proof, but yet can be readily removed to inspect or conduct maintenance or the like. Moreover, the various individual jackets are provided with self-locking rings to be releasably locked to an adjacent jacket piece when secured about a hot water pipe. Thus, maintenance and easy inspection is readily afforded by this system. In addition, the protective covers of the invention are designed with vertically arranged interior fins to provide a heat insulating quality and bruise or contusion insulation arising from contact with a pipe by the knees or legs of an individual who is wheelchair bound. Nevertheless, the covers are designed so that they will readily accommodate the hot water pipe regardless of the position of fasteners, such as nuts, on the pipe without materially compromising the protective qualities therefor. The various heat protective jackets or covers are also designed so that they have a clean aesthetically pleasing appearance to plumbing professionals. In addition, the various jackets or covers can be releasably fitted together in essentially any desired orientation to conform to an existing pipe arrangement.

### BACKGROUND OF THE INVENTION

1. Field of the Invention

This invention relates in general to certain new and useful improvements in heat protective cover systems for hot water delivering pipes and, more particularly, to a heat protective cover system of the type stated comprised of a plurality of individual cover sections or jackets which can be easily but releasably locked together and which do not permit exposure of any pipe section when joined and which also readily fits over a variety of pipe arrangements and constructions.

2. Brief Description of Related Art

The present invention is one of several originating with the inventor hereof for protecting unambulatory disabled personnel from cuts, abrasions and heat burns as a result of otherwise coming into contact with hot water pipes. The present inventor has already taught of a system as set forth in U.S. Pat. No. 5,055,334, dated Oct. 8, 1991, for Heat Protective Cover for Hot Water Pipes and a corresponding reissue U.S. Pat. No. Re 34, 832, dated Jan. 17, 1995.

It is well known and well documented that special needs arise with plumbing facilities used by unambulatory individuals and, particularly, wheelchair bound individuals. It is well known that hot water pipes located under sinks, for example, deliver hot water to a hot water tap. In like manner, waste hot water is carried away in a drain pipe which may also have a sufficiently high temperature to cause severe burns when a human knee or leg is brought into contact therewith. In addition to the foregoing, the wheelchair bound individual, who is unable to view the construction and location of the pipes, will move the wheelchair to a point approaching the sink where his or her knees will come into contact with a hot water pipe resulting in burn injuries. Notwithstanding the problems of burns, because of sharp edges on nuts and like components, bruises and cuts and similar injuries can frequently occur to an individual.

An individual in a wheelchair or other individual who is at least partially unambulatory is not capable of moving quickly and extricating himself or herself from a position of injury. As a result, when a wheelchair bound individual moves his or her knee or leg into a hot water pipe, that individual is not capable of moving away from the pipe as quickly as an individual who is fully ambulatory.

The above problems have given rise to the American Disabilities Act which requires certain types of heat protective covers on hot water pipes in order to protect the wheelchair bound individuals and others who are relatively unambulatory from burns and abrasions.

U.S. Pat. No. 4,112,967 to Withem discloses a waterproof insulated valve cover which is adapted to extend around a portion of a valve. In like manner, U.S. Pat. No. 4,555,082 to Riley, et al discloses a cover which is adapted to extend about a valve or a similar fitting in a water pipe. A similar structure, except for use with a beverage container, is taught in U.S. Pat. No. 4,401,245 to Zilla. U.S. Pat. No. 4,142,565 to Plunkett, Sr. disclosed an insulating device which extends around fluid conduit. U.S. Pat. No. 4,459,333 to Murphy discloses a similar pipe insulation product which is adapted to extend about a fluid transporting pipe.

There have been a large number of other proposed heat protective cover systems for use on hot water pipes. In addition to the above, representative of several U.S. patents which show some of these heat protective covers are:

| Patentee(s) | U.S. Pat. No. |
|---|---|
| Helmsderfer | 5,564,463 |
| Helmsderfer | 5,678,598 |
| Trueb, et al | 5,303,730 |
| Trueb, et al | 5,360,031 |
| Helmsderfer | 5,915,412 |
| Helmsderfer | 5,901,739 |

Although there have been several proposed and, for that matter, several commercially available heat protective cover systems for hot water pipes, each of these protective cover systems still suffer from one or more deficiencies. These deficiencies exist in part because the plumbing fixtures upon which the covers are used are not uniform in construction and, even more so, are not uniform in size. As a simple example, there are always variations in pipe configurations where a nut joining two pipe sections may be located. In addition, some pipes are located at different angles then other pipes. The uniformity in the construction is not available and, hence, uniformity in the mounting of the cover is not obtainable with the standard commercially available covers.

Some of the other problems which arise with these prior art heat protective covers are the fact that fasteners are frequently used on the covers or jackets to secure the jackets about a pipe section. However, the fasteners, once tightened, are not readily removable and even when they are removable, they cannot be reused. This creates a significant problem for the plumbing contractor who removes a jacket and desires to reinstall that jacket in that he or she must attempt to locate the fasteners necessary for that particular jacket. Obviously, if the fasteners are not available to the plumbing contractor, the jacket cannot be reinstalled until such time as the new fasteners can be obtained.

Another one of the problems encountered in the prior art heat protective cover systems is the fact that the various jackets do not tightly fit around the pipe sections for which they are designed to be located. As indicated above, this is due, at least in part, to the non-linearities and lack of uniformity in the assembly of these various pipe sections. Nevertheless, when one attempts to custom fit a conventional jacket to a particular pipe section, there may be portions of the jacket which are not completely closed. In that case, a portion of the pipe upon which the cover is used may be exposed. As a result, the cover system would not meet various required code sections and, in the case of a new installation, approval by municipalities would not likely be obtained.

The heat protective cover systems heretofore developed are primarily functional in nature, in that they are designed to prevent inadvertent contact of a user, such as a non-ambulatory user, from coming into contact with a hot water pipe or similar pipe structure and which could result in either heat burns or abrasions, or similar injury to the knees or legs or, for that matter, arms of a user. The heat protective cover systems of the prior art, as exemplified by the above listed patents, are deficient at very least in attempts to provide an aesthetically pleasing cover system. Inasmuch as there are now governmental requirements to use some form of heat insulative system around exposed hot water pipes, there has also developed the concomitant desire for aesthetically pleasing heat protective covers.

Many of the covers which have been developed are fairly rudimentary and do not properly fit around the various pipe sections which carry the hot water pipe. The lack of uniformity in the pipe arrangement do not allow for proper fit of the cover systems of the prior art. Nevertheless, aesthetics of the pipe cover systems has been found to be a very important factor in selection of these heat protective cover systems. The lack of attractiveness and aesthetic appearance in the prior art covers has militated against their use.

Even though these heat protective cover systems are mandated by law for safety purposes, plumbing professionals will insist upon a cover system that has a uniform smooth appearance. The generally will avoid any cover system in which fasteners are readily seen, joinder lines are noticeable and the like. Hence, outer smoothness and size uniformity are important factors.

There has been a need for a heat protective cover system for covering hot water pipes and which will easily and readily fit around and fully enclose existing hot water carrying pipes without any exposure of the pipe and which will allow for removable and reattachment with existing fasteners on the jacket.

There has also been a need for a heat protective cover system which can be authorizedly removed but which is readily resistant to vandalism and unauthorized removal. There has been a further need for a heat protective cover system of this type which is designed to properly fit around the various pipe sections and thus provide an aesthetically pleasing configuration.

### OBJECTS OF THE INVENTION

It is, therefore, one of the primary objects of the present invention to provide a heat protective cover system for enclosing hot water pipes in such manner that the pipes are fully enclosed and the cover is adapted to fully enclose all portions of the pipe for which it is fitted without any exposure of the pipe.

It is another object of the present invention to provide a heat protective cover system for hot water pipes of the type stated which utilizes fasteners of capable of being removed for easy removal of the jacket and reinstallation thereof.

It is a further object of the present invention to provide a heat protective cover system for hot water pipes of the type stated in which the same fasteners used for initially securing a jacket to a pipe section can be reused without the necessity of maintaining an inventory of additional fasteners.

It is also an object of the present invention to provide a heat protective cover system for hot water pipes of the type stated which can be used on a variety of pipe sections even though the pipe sections are not necessarily of uniform construction and which will still efficiently operate and comply with governmental code requirements.

It is another salient object of the present invention to provide a method of enclosing hot water pipes in a heat protective cover system in such manner that the pipes are fully enclosed without leaving the possibility of a user coming into contact with any portion of the pipe.

It is still a further object of the present invention to provide a heat protective cover system for hot water pipes which can be constructed at a relatively low cost and which is highly efficient in use and in application.

It is yet a further object of the present invention to provide a heat protective cover system of the type stated in which the various jackets forming part of this system have a relatively consistent outer diameter, but which will still nevertheless fit pipes of varying diameter.

It is an additional object of the present invention to provide a heat protective system of the type stated in which internal fins are located in such manner that they literally support the jackets on the pipe sections and thus provide an aesthetically pleasing appearance.

It is still another object of the present invention to provide a heat protective system of the type stated in which the various jackets forming a part of the system can be readily and authorizedly removed from a pipe arrangement, but which are still nevertheless relatively resistant to unauthorized removal and vandalism.

It is also an important object of the present invention to provide a method of applying heat protective covers to a hot water pipe arrangement and which is adapted to fit that pipe arrangement in an aesthetically pleasing manner and which is nevertheless resistant to unauthorized removal therefrom.

With the above and other objects in view, my invention resides in the novel features of form, construction, arrangement and combination of parts and components presently described and pointed out in the claims.

### BRIEF SUMMARY OF THE INVENTION

The present invention relates to a heat protective cover system for hot water pipes which is comprised of a plurality of individual jackets capable of releasably connecting to one another. Each of the individual jackets forming part of the system of the invention are preferably formed of a vinyl or other plastic material and have some slight rigidity, but are nevertheless bendable and readily conformable to an existing pipe configuration.

The system of the invention is comprised of jackets having various shapes which normally conform to portions of standard pipe arrangements under many sinks. For example, the heat protective covers or jackets will include one having a U-shaped configuration, one having an L-shaped configuration, another having a straight line arrangement, an elbow arrangement, and the like. Thus, each of these components are capable of being fitted together to accommodate the vast majority of pipe configurations one would expect to find in standard piping arrangements under a sink or similar structure. In addition, and due to the fact that some standard pipes or the so-called “flex pipes”, that is pipes having somewhat of a flexible nature, but of reduced diameter compared to a standard copper or steel pipe are employed, reduced diameter jackets are also provided in accordance with the system of the invention.

Jackets forming part of the heat protective cover system of the invention are generally all split along one longitudinal margin so that they are capable of being separated and effectively wrapped about a pipe section. Thus, when fitted about the pipe section, the two half sections of the jacket which are still integral with one another beyond the split, will again join along the split line and are capable of being fastened together by means of fasteners. Mating apertures are formed along the slit line which allows the two portions of the jacket to be secured together by means of such fasteners.

One type of fastener which is employed is in the nature of a screw. These screws are quite small so that they fit within and would be generally retained within the holes on one side of the split line and are capable of being threadedly received in the holes on the opposite side of the slit line. Moreover, these fasteners, although accessible, are not easily removable without the appropriate tools and without bending down and supporting oneself in a either prone or kneeling position to remove the screws and thereby remove the individual pipe sections. In this respect, the various individual jackets are therefore relatively free of vandalism and unauthorized removable. However, by using the proper tools with a work person in a proper position, the jackets can be readily removed to expose the individual pipe sections.

The jackets used for wrapping about the various pipe sections in accordance with the present invention may contain horizontally arranged transversely spaced apart longitudinally extending fins. Thus, in a circular jacket which is vertically arranged, the fins would be disposed in a vertical position and horizontally spaced apart from one another. This arrangement allows the fins to flex in order to avoid protuberances on piping arrangements and also allows for the fins to snugly engage a nut or like coupling element to aid in supporting the jacket in a fixed position on a pipe arrangement. The fins also serve to at least provide some spatial relationship between the pipe and the jacket, thereby further enhancing the heat insulative qualities.

The individual pipe sections of the present invention are generally all formed with a constant diameter for standard pipe pieces. There are also the flex pipes and other similar pipes of reduced diameter. For this purpose, smaller diameter pipe jackets are also provided. Due to the fact that the various jackets for standard pipe configurations all have essentially one diameter, when connected together, they form an aesthetically pleasing cover system. Moreover, when connected together, they appear as though they form an integral total unit which covers a pipe arrangement.

The present invention utilizes set screws as fasteners and, even more so, set screws which have male socket heads, as opposed to the standard female socket head. Thus, this type of construction further deters theft and vandalism. Moreover, this is important, since many governmental regulations require tamper resistant products.

This invention possesses many other advantages and has other purposes which may be made more clearly apparent from a consideration of the forms in which it may be embodied. These forms are shown in the drawings forming a part of and accompanying the present specification. They will now be described in detail for purposes of illustrating the general principles of the invention. However, it is to be understood that the following detailed description and the accompanying drawings are not to be taken in a limiting sense.

### BRIEF DESCRIPTION OF THE DRAWINGS

Having thus described the invention in general terms, reference will now be made to the accompanying drawings in which:

FIG. 1 is a perspective view of a J-shaped heat protective jacket forming part of the heat protective cover system of the present invention and in accordance with the design of the present invention;

FIG. 2 is a side elevational view of the J-shaped jacket of FIG. 1;

FIG. 3 is a rear elevational view of the J-shaped jacket of FIG. 1;

FIG. 4 is a front elevational view of the J-shaped jacket of FIG. 1;

FIG. 5 is a top plan view of the J-shaped jacket of FIG. 1;

FIG. 6 is a bottom plan view of the J-shaped jacket of FIG. 1;

FIG. 7 is an exploded perspective view showing a drain cap removed from the J-shaped heat protective jacket of FIG. 1;

FIG. 7A is an enlarged fragmentary vertical sectional view taken along line 7A-7A of FIG. 7 and showing a modified form of jacket coupling to the end of the J-shaped jacket of FIG. 1;

FIG. 8 is an exploded fragmentary perspective view of a portion of the jacket of FIG. 1 and where mating edges of the jacket along a split line are spread apart to expose a portion of the interior of the jacket;

FIG. 9 is a horizontal sectional view taken substantially along line 9-9 of FIG. 4 and showing a portion of a pipe covered thereby in phantom lines therein;

FIG. 10 is a horizontal sectional view, similar to FIG. 9, and showing internal fins in a position where they are laterally displaced with a larger diameter pipe;

FIG. 11 is a horizontal sectional view taken substantially along line 11-11 of FIG. 4;

FIG. 11A is an enlarged vertical sectional view taken through a lock housing forming part of the jacket of FIG. 1 and showing the interior construction thereof and taken substantially along line 11A-11A of FIG. 11;

FIG. 12 is a perspective view of an L-shaped heat protective jacket in accordance with the present invention;

FIG. 13 is a side elevational view of the L-shaped jacket of FIG. 12;

FIG. 14 is a rear elevational view of the L-shaped jacket of FIG. 12;

FIG. 15 is a front elevational view of the L-shaped jacket of FIG. 11;

FIG. 16 is a top plan view of the L-shaped jacket of FIG. 12;

FIG. 17 is a bottom plan view of the L-shaped jacket of FIG. 12;

FIG. 18 is a partial vertical sectional view taken substantially along line 18-18 of FIG. 16;

FIG. 19 is a side elevational view showing a combination of an assembled J-shaped jacket of FIG. 1 and the L-shaped jacket of FIG. 12;

FIG. 20 is a front elevational view of the combination of J-shaped jacket and L-shaped jacket shown in FIG. 19;

FIG. 21 is a vertical sectional view taken substantially along line 21-21 of FIG. 20;

FIG. 22 is a perspective view of a heat protective cover for a linear hot water pipe in accordance with the present invention;

FIG. 23 is a side elevational view of the jacket of FIG. 22 with the opposite side elevational view being substantially identical;

FIG. 24 is a rear elevational view of the jacket of FIG. 13;

FIG. 25 is a front elevational view of the jacket of FIG. 22;

FIG. 26 is a top plan view of the jacket of FIG. 7;

FIG. 27 is a bottom plan view of the jacket of FIG. 7;

FIG. 28 is a vertical sectional view taken along line 28-28 of FIG. 26;

FIG. 29 is a perspective view of an elbow or valve receiving jacket forming part of the heat protective cover system of the invention and in accordance with the present invention;

FIG. 30 is a side elevational view of the jacket of FIG. 29;

FIG. 31 is a rear elevational view of the jacket of FIG. 29;

FIG. 32 is a front elevational view of the jacket of FIG. 29;

FIG. 33 is a top plan view of the jacket of FIG. 29;

FIG. 34 is a bottom plan view of the jacket of FIG. 29;

FIG. 35 is a side elevational view of a combination of the elbow valve receiving jacket of FIG. 29 and the linear hot water pipe of FIG. 22 in assembled relationship;

FIG. 36 is a front elevational view of the combination of the elbow valve receiving jacket and the linear jacket for the hot water pipe;

FIG. 37 is an exploded vertical sectional view of the elbow or valve receiving jacket with a hot water pipe jacket shown in a position to be connected to a side port thereof;

FIG. 38 is a vertical sectional view, similar to FIG. 37, and showing the components of FIG. 37 in fully assembled relationship;

FIG. 39 is a perspective view of a somewhat Z-shaped jacket forming part of the heat protective cover system of the invention and in accordance with the design of the invention;

FIG. 40 is a side elevational view of the Z-shaped jacket of FIG. 39;

FIG. 41 is a rear elevational view of the Z-shaped jacket of FIG. 39;

FIG. 42 is a front elevational view of the Z-shaped jacket of FIG. 39;

FIG. 43 is a top plan view of the Z-shaped jacket of FIG. 39;

FIG. 44 is a bottom plan view of the Z-shaped jacket of FIG. 39;

FIG. 45 is a side elevational view of a modified form of fastener used in the present invention;

FIG. 46 is a fragmentary exploded vertical sectional view, similar to FIG. 35, showing a modified form of valve or elbow receiving jacket forming part of the present invention;

FIG. 47 is a vertical sectional view similar to FIG. 46 and showing the elbow or valve receiving jacket in a fully assembled condition;

FIG. 48 is a fragmentary exploded perspective view showing the bottom portion of the elbow or valve receiving jacket in the assembly of FIGS. 46 and 47;

FIG. 49 is a side elevational view of a modified form of combination of J-shaped jacket and L-shaped jacket;

FIG. 50 is a front elevational view of the jacket assembly of FIG. 49;

FIG. 51 is a vertical sectional view taken substantially along line 51-51 of FIG. 50; and

FIG. 52 is a fragmentary perspective view showing still another modified form of lock housing used for receiving the locking fasteners in the present invention.

### DETAILED DESCRIPTION OF A PREFERRED EMBODIMENT

Referring now in more detail and by reference characters to the drawings, which illustrate several practical embodiments of the present invention, there are illustrated and described a system of several different types of jackets or covers which may be disposed over hot water pipes. There are also several fasteners used with the jackets and forming part of the system of the invention.

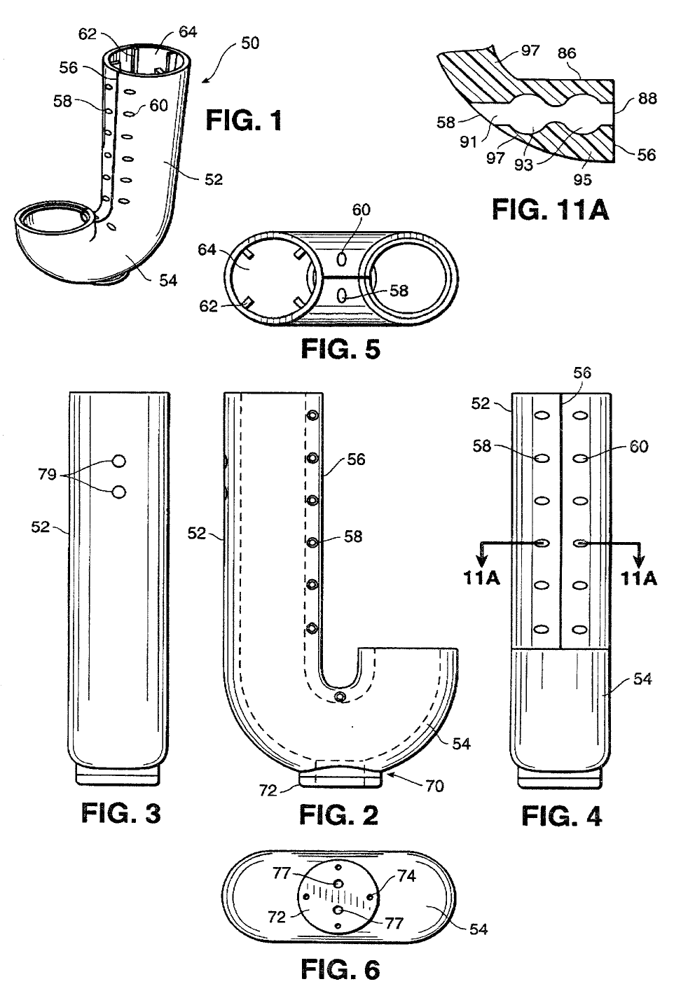

The first jacket designated by reference numeral 50 is a so-called “J-shaped” jacket. The J-shaped jacket 50 is comprised of a first generally vertically disposed leg 52 and an integrally formed somewhat U-shaped section 54. The entire jacket is provided with an elongate slit 56, as best shown in FIGS. 1 and 4, and which allows the jacket to be effectively opened along the slit and the two sections thereof separated so as to fit around a pipe. After the jacket has been biased back to its original position by means of the elasticity of the material of construction, the slit 56 will close together, such that one only observes a line 56, as shown in FIG. 4.

The jackets forming part of this system must be formed of a somewhat flexible and bendable material and should also have a sufficient degree of elasticity so that they can be bent away from their original position and allowed to normally return to the original position through the inherent memory caused by the elasticity of the material. In this respect, any of a number of materials could be used. However, several polyolefins, such as polyethylene, polypropylene and the like could be used. In addition, polyvinyl chloride could also be used as a material of construction.

Located on opposite sides of the slit 56 are pairs of apertures 58 and 60. In this respect, the each of the apertures 58 and 60, in a pair, are aligned to accommodate fasteners, in a manner as hereinafter described. The rows of apertures and, hence, fasteners will extend along the vertically disposed leg 52 and even into the lower end of the U-shaped section 54 adjacent the slit 56. Inasmuch as the two sections of the jacket are normally biased back together through the elasticity of the material, they are located on a circumferential portion of the jacket and, hence, adopt elliptical shapes, as best illustrated in FIGS. 1 and 4 of the drawings. However, the apertures 58 and 60 will completely accommodate a fastener in a manner to be hereinafter described in more detail, such that the fastener completely fills each of the apertures 58 and 60 and, thus, provides an appearance similar to that of the surface of the jacket itself. In other words, if the fasteners are formed of the same color as the jacket, the fasteners effectively blend into the jacket.

Located on the interior surface of the jacket 50 is a plurality of (four as shown) inwardly projecting fins 62 and which extend into an elongate opening 64 sized to receive a pipe or similar plumbing component. The fins 62 only extend for the length of the vertical leg 52, but do not extend into the U-shaped sections 54, as best shown in FIGS. 1, 2 and 5 of the drawings. In accordance with this construction, when the jacket is fitted around a pipe, the fins 62 can be displaced and yield somewhat to the position as shown, for example, in FIG. 10.

In FIG. 9, there is illustrated a pipe 66 of a specified diameter such that it just engages the tips of each of the fins 62. However, in FIG. 10, it can be observed that there is a slightly larger diameter pipe 68 upon which the jacket is used, thus deflecting the fins 62 to the side, as best shown in FIG. 10.

In accordance with this construction, the fins 62 provide an additional type of insulation. The jacket itself is formed of a material of construction and has a wall thickness sufficient to insulate against the heat contained in the hot water pipe, such as the pipes 66 and 68. However, the fins 62 are sufficiently rigid such that they will hold the jacket about the pipe in spaced apart relationship to the pipe. Even if they did not hold the pipe in spaced apart relationship, when they are bent or deflected completely to the side, they still interfere with the pipe actually contacting the inner surface of the wall of the jacket.

Located at the lower end of the U-shaped section 54 is a trap, such as a water trap 70 and which is integral with the bottom end of the U-shaped section 54. This trap 70 allows for draining of any water which may have condensed or otherwise entered into the jacket. It also is effective in removing any dead insects which may have found a way into the space between the pipe and the jacket. Moreover, this trap 70 is effective to allow repair to the U-shaped portion of the pipe, if needed.

Located over the trap 70 is a removable cover 72 and which is provided with a plurality of spaced apart screw holes 74 for receiving locking screws 76. The cover 72 is provided with an internal circular flange 78 which snugly fits within the opening of the trap and the cover is thereupon disposed over the trap in the manner as shown in FIGS. 2 and 4 and retained therein by means of the locking screws 76.

In accordance with this construction, it is relatively easy and convenient to obtain access to the interior of the U-shaped section without otherwise necessitating the removal of the entire jacket. This condensation trap therefore fulfills a very effective purpose in accordance with the present invention.

The cover 72 is also provided with a pair of weep holes 77, as best shown in FIG. 6. These weep holes 77 allow for drainage of any condensation which may form before actual removal of the cover 72. In accordance with the present invention, a pair of the weep holes are provided so as to also allow for air flow through the bottom of the jacket. It should also be understood in connection with the present invention that weep holes may also be provided at other places as, for example, in the rear of the jacket 52. Again, these weep holes would be used in pairs. In fact, by reference to FIG. 3, it can be observed that the rear surface of the jacket 50 is provided with a pair of weep holes 79.

The apertures 58 and 60 are designed to receive fasteners, such as fasteners 80 illustrated in FIG. 8. These fasteners 80 are somewhat in the nature of set screws and have a threaded shank 82 along with a male head 84. When the fasteners are introduced into the apertures 60, the heads 84 will actually snugly fit within the apertures and effectively recess within the apertures 60. Consequently, they are not necessarily removable in the absence of an Allen-type wrench. Moreover, since they are effectively recessed in the apertures, they are not readily removable by someone who is unskilled in the removal of these fasteners. As a result, the use of these fasteners in the combination with these particular apertures is an effective deterrent against theft and vandalism.

One of the unique aspects of the present invention is the fact that the fasteners are designed to fit snugly within the adjoining apertures 58 and 60, as well as in other corresponding pairs of apertures in the other jackets as hereinafter described. Specifically, the length of the shank in the fastener has been determined so as to insure that the two jackets remain together in tightly abutted position when the fasteners are inserted in the apertures 58 and 60. In this way, there is less likelihood that one can insert his or her fingers in the slit 56 in order to attempt to pry the same open. In fact, it has been determined that it would take a minimum of 170 pounds of force in order to pull the slit open against the action of these fasteners. Consequently, the possibility of theft or vandalism is greatly reduced.

The applicant has also found that it is possible to use approximately only 50% of the pairs of apertures compared to those used in prior art constructions. Due to the fact that the fasteners have such a tight gripping action and there is little or no play in the fasteners when inserted in the pairs of apertures, there is no need for a large number of fastener receiving apertures. In fact, it has also been found in connection with several prior art structures that the fasteners literally tend to break when inserted in two pairs of aligned apertures. Consequently, a large number of these prior art fasteners are needed to obtain any type of securement and, even in this case, they are not theft proof or vandal proof.

Another one of the factors in the present invention which precludes theft and vandalism is the fact that there is a generally smooth contour on the outer surface of the jackets. When the sections of the jacket at the slit are held tightly together, it is much more difficult for one to insert fingers in the slit in order to separate the two sections of the jacket at the slit. In order words, one does not obtain a sufficient gripping in order to rip the product off of a pipe section. Further, the fact that there are less number of clips or fasteners allows much more easy and less time consuming installation.

The apertures 58 and 60 are not merely apertures, as such, but lead into locking hubs 86 on the inner surface of each of the at each of the apertures on opposite sides of the slit. FIG. 8 shows the jacket in a partially opened condition and shows hubs 86, in the nature of fastener-receiving lock housings, leading to the apertures 58. These hubs 86 similarly have apertures 88 which are in communication with the apertures 58.

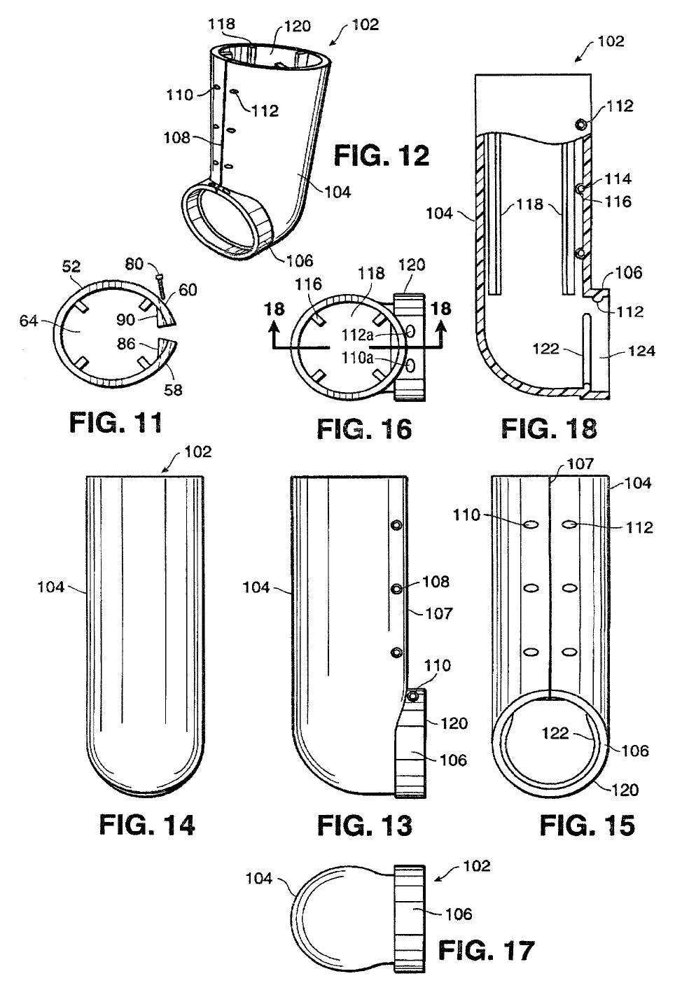

Although not specifically illustrated in FIG. 8, the jacket also contains hubs 90 similar to the hubs 88 on the inside of each of the apertures 60. Thus, each fastener is fitted within a hub and retentively held within that hub and the threaded shank 82 projects to the apertures 88 in the hub 90 on the opposite side of the jacket. Thus, an aperture 58 of each pair on the same side of the slit 56 leads to an inner aperture 88. However, the fasteners in the aperture 58 are held within the housing 86 and releasably lock into housings or hubs 90 on the opposite side of the slit 56. The hubs 90 are more fully illustrated in FIG. 11 of the drawings. Although a pair of fasteners are shown in this FIG. 11, it should be understood that only one fastener would be used in any pair of apertures. However, fasteners can be inserted through either of the apertures in a pair.

The hubs, which are in the nature of lock receiving housings, as indicated above, also contain locking elements. These locking elements can be nuts which are sized to receive the screws or otherwise they can be elongate channels leading from the apertures to the openings on the opposite side of each of the hubs. Moreover, since the hubs are formed of a plastic or rubber like material having some yieldability, they will effectively engage the shanks either of the pins or the threads on the shanks of the screws and thereby tightly hold the fasteners within the associated apertures and hubs.

It is also possible to provide abutting shoulders as locking elements in these channels, as hereinafter described, so that the shoulders on the pins will engage these abutting shoulders and thereby hold the pins in the apertures and hubs.

In accordance with this construction, when a fastener 80 is rotated in an unlocking rotation, it will become separated from the hub 86 leading to the apertures 58 on the opposite side of the slit 56. However, the fasteners 80 will be retentively held within the hubs 90 on the same side of the jacket in which the apertures 60 exist. In this way, even though a fastener 80 is removed from the hub 90 on one side of the jacket, it will be retentively held within the hub 86 on the same side of the jacket as the aperture 60. In this way, the fasteners will not be readily lost.

FIG. 11A more fully illustrates the interior construction of each of the hubs, such as the hubs 88 and 90. Thus, one such hub 88 is hereinafter described in more detail in connection with FIG. 11. Within each hub there is an elongate channel 91 extending between the outer aperture 58 and the inner aperture 88. In addition, and located within each channel 91 are enlarged grooves or box-like recesses 93 separated by an inwardly projecting diametrically reduced ring 95. This ring 95 presents outwardly located abutment walls 97 specifically sized to retain a pin type fastener of the type hereinafter described in more detail. However, these pin type fasteners do have enlarged heads and the enlarged heads have end faces which will engage within the abutment walls 97 in the recess for holding the fastener therein. In like manner, the remaining portion of the elongate channel 91, including the recesses 93, are sufficiently narrow, such that they will engage and retentively hold the shank of a screw type fastener.

It is also to be noted that the male heads 84 of the screws allow for insertion and recessing in the apertures 60. In this way, the surface of the heads will extend generally to the surface of the jacket. Inasmuch as they are both made of the similar materials and the same color, the fasteners will not be readily observable. They have been illustrated with solid lines of demarcation in FIG. 8 of the drawings, but merely to show the actual details of construction. However, in actuality, the fasteners are not readily observable unless one closely examines the jacket.

FIG. 45 illustrates an embodiment of a different type of fastener 92 in the nature of a pin and is frequently referred to as a “clip”. This pin 92 is provided with a shank 94 and a pair of enlarged ends 96. However, it can be observed that each of the enlarged ends have inwardly directed arcuate faces 100 and outwardly tapering side walls 101 terminating in outer rounded ends 102, as best shown in FIG. 45. The inner ends of the enlarged ends 96 are diametrically enlarged thereby tightly but nevertheless removably holding the pins 92 in the elongate channel 91.

In accordance with this construction, when a pin is inserted into a pair of aligned apertures in the jackets of the invention, such as the apertures 58 and 60, the ends 98 will essentially fill the aperture as though it were a part of the jacket. This type of fastener is highly effective in completely precluding unauthorized removal. However, by using a special type of thin nosed pliers, one can engage an end of the pin, usually by one of the heads of the pin, and pull the same outwardly from the hub on the opposite side of the slit 56. In this way, the jacket is again precluded from theft or vandalism. However, by using authorized tools, a work person can remove the pins in order to obtain access to the interior of the jacket and to the pipe covered by the jacket.

Although the fasteners, whether they be pin-type fasteners or screw-type fasteners, can be removed, they are inserted in the openings in such manner that special tools may be required to remove them. Typically, the average vandal or thief is not in a position to have all of the necessary tools which may be needed. Moreover, and although the covers are not absolutely vandal proof or theft proof, it is quite difficult for the average thief or vandal to assume the necessary prone or kneeling position in order to remove these components without being observed. In that sense, the covers are effectively vandal proof and theft proof.

These pins 92 are preferably formed of a relatively rigid plastic material, again such as polyethylene or polypropylene. However, any material of construction could be used in the formation of the pins.

Although the material of construction used in the formation of the jackets is relatively durable and has some rigidity, it is still nevertheless sufficiently pliable, such that screw shanks can be forced into the openings and, moreover, the heads can snugly fit within the various apertures. When pushed into the apertures, they are difficult to engage without a special type of thin nosed pliers. Consequently, they are relatively secure against vandalism.

It should also be understood in connection with the present invention that it is possible to use ties, such as strap-like ties, having securement ends, such that the ties will extend through aligned apertures of the jacket and are secured externally of these apertures. However, and although ties can be used, they are not as vandal proof as the other fasteners described herein.

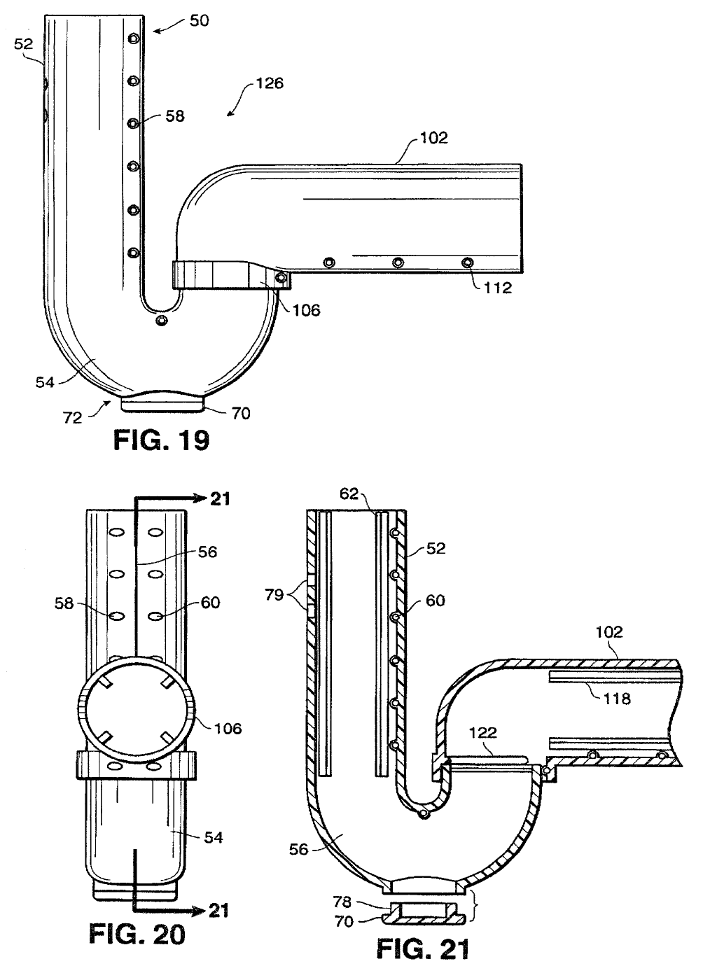

FIGS. 12-17 illustrate a so-called “L-shaped” jacket 102 and which is comprised of an elongate vertically arranged leg 104 and a short angularly located leg 106 and which is typically located at right angles to the leg 104. The leg 106 is merely a short stub at the very end of the vertical section 104, in the manner as best shown in FIGS. 12, 13 and 18 of the drawings. Although the jacket 102 is vertically arranged, as shown in FIGS. 11-18, it is frequently used in the horizontal arrangement, typically as shown in FIGS. 19-21.

The entire jacket is also provided with a slit 108 extending throughout the length of the jacket, including both the leg 104 and the stub leg 106. Located on opposite sides of the slit line are apertures 110 substantially identical to the apertures 58 and on the other side thereof apertures 112, substantially identical to the apertures 60. Moreover, each of the apertures lead into locking hubs (see FIG. 18) located on the inside of the jacket. By further reference to FIG. 18, it can be observed that the apertures 112 lead into locking hubs 114 having openings 116 communicating with the apertures 112. In like manner, it should be understood that the apertures 110 would similarly lead into hubs located on the inside of the jacket and adjacent the slit 108.

The apertures 110 and 112, as well as the locking hubs associated therewith, operate substantially identically to similar apertures 58 and 60 in the jackets of FIGS. 1-11 and retentively hold either said screw type fasteners, such as the fasteners 80 or locking pins, such as the pins 92. Consequently, no further illustration or description is provided with respect to locking of the jackets 102.

The jackets 102 are similarly provided with fins 118 on the interior bore 120, as best shown in FIGS. 16 and 18. These fins 118 are again substantially identical to the fins 62 and operate in essentially the same manner as fins 62 in maintaining a spacing of the jacket with respect to a pipe disposed therein.

By further reference to FIGS. 12, 13 and 16-18, it can be observed that the stub 106 is actually constructed in the form of a fitting. This stub-fitting 106 is provided with additional thickness and effectively operates as a type of reinforcement when the jacket 102 is connected to another jacket section, as hereinafter described. In this respect, the stub fitting 106 is provided with a pair of fastener receiving apertures 110a and 112a on opposite sides of the slit 108. These apertures 110a and 112a are similar to the apertures 110 and 112, respectively, and are located to receive a fastener and, more specifically, a screw-type fastener. In this way, the L-shaped jacket 102 can be physically locked to the J-shaped jacket or, for that matter, any other jacket in accordance with the present invention.

It should also be observed that these apertures 110a and 112a also allow for a type of size fitting adjustment. Frequently, the J-shaped jacket 50 and the L-shaped jacket 102 are connected together in the region of a locking nut (not shown) which holds a J-shaped pipe section and a L-shaped pipe section together. In many cases, these locking nuts are not of an absolute standard size. Accordingly, tightening of the screws or release of the locking screws used in the apertures 110a and 112a provide for a type of adjustment of the jacket around the locking nut.

Located on the inner surface of the stub-fitting 106 is a flange 122 serving as an abutment flange, such that another jacket section inserted into the stub-fitting 106 will abut against and stop at the flange 122. By reference to FIG. 18, it can be observed that there is a space 124 allotted for receipt of the end of another jacket section. Moreover, a pair of the aforesaid apertures 110 and 112 are located at this stub-fitting 122 and have locking hubs 114 located on the interior thereof. In this way, the other pipe section can be retentively held within the stub-fitting 106.

FIGS. 19-21 illustrate an assembly 126 of a J-shaped jacket 50 and the L-shaped jacket 102 of FIGS. 12-18. This assembly 126 is essentially substantially identical in construction to the jacket 50 of FIGS. 1-11 and the jacket 102 of FIGS. 12-18. Hence, these particular components are neither illustrated nor described in any further detail in FIGS. 19-21.

However, it is important to note that the jackets are uniquely designed so that they are capable of retentively engaging one another and being held together in a tightly assembled position.

By reference to FIGS. 19-21, and particularly, FIGS. 19 and 21, it can observed that the stub-fitting 106 of the jacket 102 fits over the end of the U-shaped section 54 forming part of the jacket 50. Thus, the free end of the U-shaped section 54 actually snugly fits within the socket formed by the stub-fitting 106 and is tightly, but nevertheless removably, held therein. In addition, it can observed that, since there are locking apertures located directly at the stub-fitting 106, the end of the jacket 102 can be lockably retained around the end of the U-shaped section 54, in the manner as illustrated in FIG. 19. It can also be observed that the end of the U-shaped section 54 will abut against the interior flange 122, such that the two are properly joined together in the desired relationship and are locked together in that position.

By further reference to FIG. 21, it can be observed that the removable cap 72 can be removed from and reattached to the drain plug 70. Thus, this assembly allows withdrawal of water condemnation from the J-shaped pipe.

In one of the important aspects of the present invention, it can be observed that although the stub-fitting 106 is slightly diametrically larger than the end of U-shaped section 54, there is a generally continuous appearance, such that the two jackets appear to flow together in a rather smooth continuum. Nevertheless, the stub-fittings actually hidden by the J-shaped pipe in actual construction.

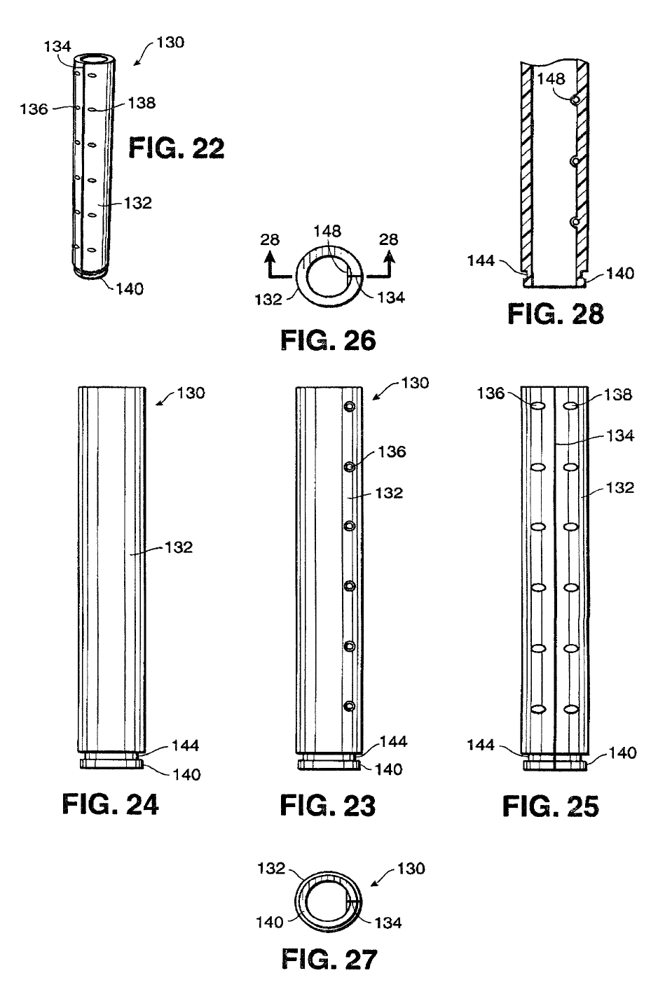

FIGS. 22-28 more fully illustrate a jacket 130 for a linear hot water pipe. In this case, it can be observed that the jacket contains a cylindrically shaped side wall 132 having a longitudinal slit 134 over its entire length. In a manner similar to the jacket 50, fastener receiving apertures 136 and 138, respectively similar to the fastening receiving apertures 58 and 60, are also provided adjacent the slit 134. In FIG. 22, each of the apertures 136 and 138 are also provided with hubs 148 (see FIG. 28) and which operate in the same manner as the previously described hubs or fastener receiving housings 88 and 90. Thus, these apertures and the associated hubs will receive those fasteners previously described.

The jacket 130 can also be opened and spread apart along the slit 134 and separated so as to be enclosed about a pipe section. Although the jacket is shown as being formed for a linear pipe, it should nevertheless be understood that the typical linear pipe may be formed of a flex pipe material for carrying hot water. In that case, the flex pipe may be capable of being bent or configured to a desired arrangement. In this case, since the jacket is also formed of a flexible material, it can similarly be bent to conform to the particular pipe arrangement.

The lower end of the jacket 130 is provided with an integrally formed locking ring 141 and which is integral with the lower end of the side wall 132 through a recessed connecting strip 144, as best shown in FIGS. 23-25. This recessed connecting strip 144 serves to releasably lock the jacket 130 to another jacket, as hereinafter described in more detail.

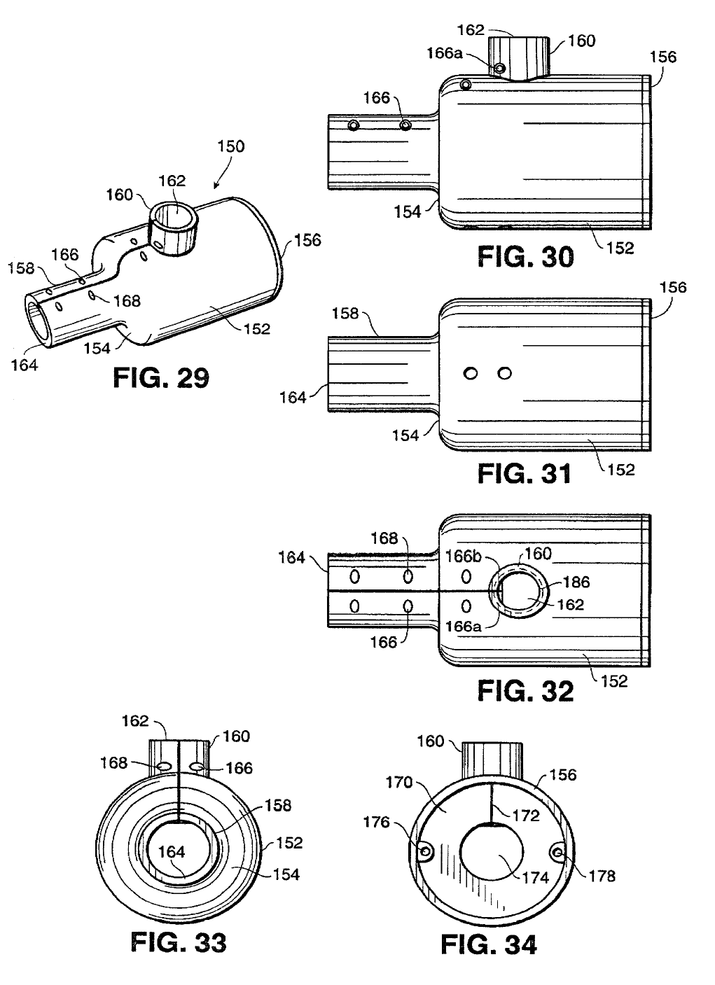

FIGS. 29-34 illustrate an elbow or valve receiving jacket 150 which is comprised of an outer somewhat cylindrically shaped jacket section 152 along with an integrally formed somewhat arcuately shaped end wall 154 and a lower end 156, as hereinafter described in more detail. The somewhat arcuately shaped end wall 154 integrally merges into a socket forming extension 158 and which is sized to receive a standard pipe, as hereinafter described.

The cylindrically shaped jacket section 152 is similarly provided with an outwardly extending socket forming extension 160, as best shown in FIGS. 29, 30, 33 and 34. This socket forming extension 160 forms a socket 162 for receiving a reduced diameter pipe and pipe jacket. Thus, a linear pipe, such as a pipe used with a jacket 130, could be located to extend into the valve or elbow covered by the jacket section 150, also in a manner as hereinafter described in more detail.

The integrally formed stub pipe section 158 and the cylindrically shaped wall 152 are also slit longitudinally from an upper end of the stub pipe 158 to the socket forming pipe 160, as best shown in FIGS. 29 and 32 of the drawings. In this way, the jacket can be fitted around an elbow or valve or like structure. Moreover, the jacket is similarly provided with apertures 166 and 168, similar respectively, to the apertures 58 and 60. These aligned apertures 166 and 168 would receive fasteners similar to those previously described. However, it is important to note that apertures 166a and 168b are also located on the socket forming pipe section 160, as best shown in FIG. 33 of the drawings. Again, these apertures 166a and 168a also are designed to receive fasteners, such that the socket forming section 160 can be adjustably sized to accommodate differing sized pipes located within the jacket 130.

The lower end 156 of the jacket section 150 is provided with a removable bottom plate 170 and which is similarly provided with a slit 172 to extend about a pipe section. In like manner, the bottom plate 170 is also provided with an enlarged central opening 174 to receive yet another pipe, if desired, for connection to the valve or elbow (not shown). Finally, the lower end 156 is provided with ears 176 and screw receiving apertures 178 for locking the bottom plate 170 to the jacket, in the manner as shown. For this purpose, small set screws 180 (see FIG. 37) may be used.

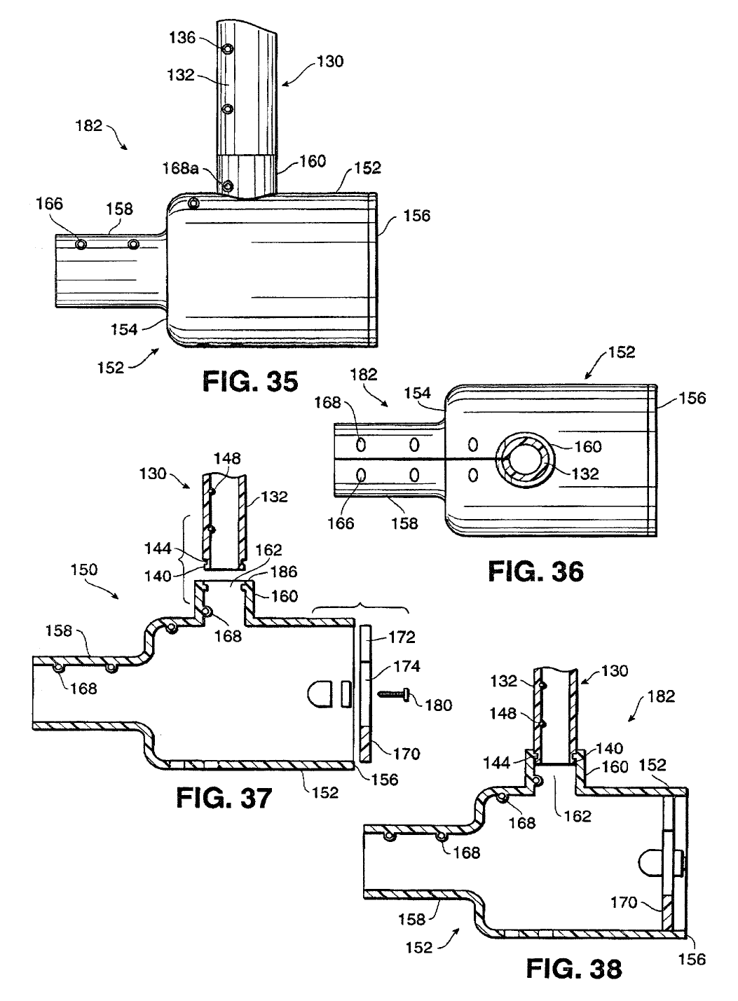

FIGS. 35-38 illustrate an assembled combination 182 of the elbow or valve covering jacket 152 and the linear pipe section jacket 130. In this case, it can be observed and, particularly, by reference to FIGS. 37 and 38, an individual pipe, such as the linear flex pipe jacket 130, having a relatively small diameter may be connected to a valve or elbow jacket. In this case, the valve or elbow would allow a reduced diameter pipe to be connected directly thereto and the jackets operate in combination so as to fully enclose the combined structure.

This combination of the components, as illustrated in FIGS. 35-38, shows the uniqueness of the jackets forming part of the system of the present invention, in that they are designed to cover essentially any type of arrangement in which one encounters plumbing pipe components, such as larger diameter pipes and smaller diameter pipes as well as the valves, elbows and fittings therefor.

It can be seen in accordance with this arrangement as shown in FIGS. 35-38 that the entire assembly can be completely enclosed in accordance with government regulations and, moreover, to insure complete safety to an unambulatory individual.

It can also be observed in accordance with the present invention that the groove 144 formed by the enlarged lower end 140 on the linear pipe jacket 130 is capable of fitting within a protruding flange 186 located at the entrance of the stub pipe section 160. In this way, when fasteners are located in the combined fastening receiving apertures 166 and 168 around this stub pipe section 160, the two components will be lockably retained together.

The combination 182 as illustrated in FIGS. 35-38 illustrate the versatility of the pipe cover system of the present invention. In that, in this case, two different diameter pipe sections can be capable of being coupled together and completely covered to be in compliance with government requirements and also to insure safety to unambulatory individuals. These components also illustrate the fact that differing diameter pipe sections as well as valves, various coupling member fittings, and the like, can be all combined and all of them are advantageously covered by the pipe cover system of the present invention. The illustrations of FIGS. 35-38 thus only illustrate a few of the components that can be combined and completely covered by the pipe cover system of the invention.

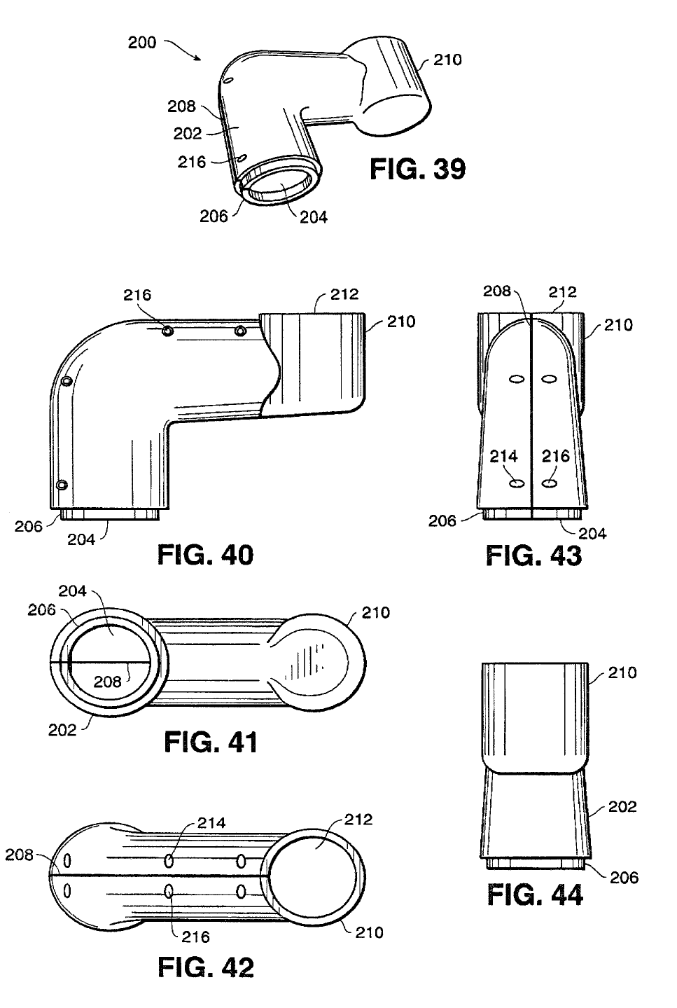

FIG. 39-44 illustrate yet another pipe cover 200 in accordance with the present invention. Here again, this pipe cover, although not shown in combination with other pipe covers, nevertheless can be combined much in the same manner as the combination as shown in FIGS. 35-38.

The pipe cover 200 as illustrated in FIGS. 39-44 is often referred to as a “Z pipe cover”. In this case, the Z pipe cover comprises a first section 202, which is somewhat L-shaped, and has one opened end 204 surrounded by a coupling flange 206. In this case, the coupling flange is capable of being fitted into an opening of another pipe cover section and retentively held therein. As a simple example, the flange could be inserted into the opening of the U-shaped section 54 and lockably retained therein through the mating apertures 58 and 60. The L-shaped section 202 is similarly provided with an elongate slit 208 in order to enable the pipe cover 200 to be separated and wrapped about a pipe section having a somewhat similar configuration.

The lower end of the L-shaped section 202 integrally merges into a lower leg 210 which is also provided with an opening 212 in opposite directions to the opening 204. Thus, a pipe can be connected to the opening 212 and another pipe connected to the opening 204 when the two are located at a different elevations relative to one another. The jacket 200 of this embodiment of the invention will effectively cover that type of pipe arrangement.

Again, it is to be recognized that the pipe cover system as illustrated in FIGS. 39-44 is only one of several pipe cover sections which can be used. Although the pipe cover section 200 allows for covering of two pipes located in spaced apart relationship to one another, this jacket can be used in a variety of other configurations as well. Moreover, it can be used in combination with any of the jackets previously described.

As indicated previously, the pipe cover section is provided with a slit 208. In addition, mating apertures 214 and 216 are located on opposite sides of the slit 208. These matching apertures cooperate in the same manner as the previously described apertures 58 and 60 and would similarly be provided with fastener receiving housings similar to those provided with the apertures 58 and 60.

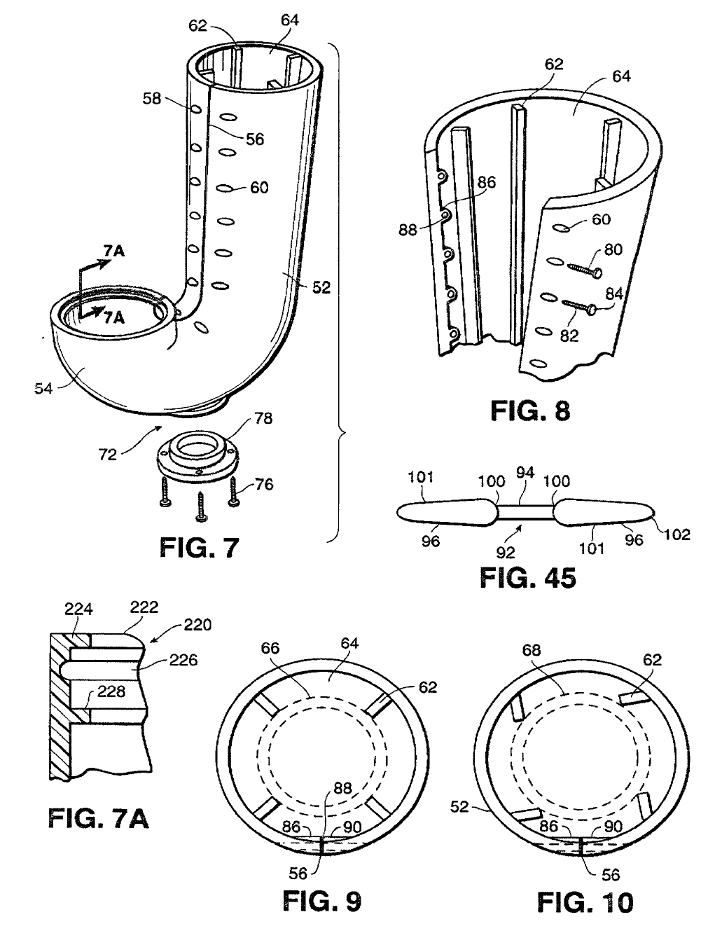

FIG. 7A illustrates a modified form of J-shaped jacket 220. In connection with this modified J-shaped jacket and the other modified embodiments as hereinafter described, like reference numerals which were used in connection with previously described embodiments may also be used with these new embodiments.

The jacket 220 is similar in construction to the previously described J-shaped jacket, except for the fact that short U-shaped portion 54 has an open end 222. In this case, the jacket is provided with an inwardly struck circularly shaped gripping flange 224 which is adapted to engage a recess on a L-shaped jacket 102. Moreover, the open end 222 is provided with a cylindrically shaped recess 226 as well as a lower inwardly projecting angular flange 228, all in the manner as best shown in FIG. 7A of the drawings.

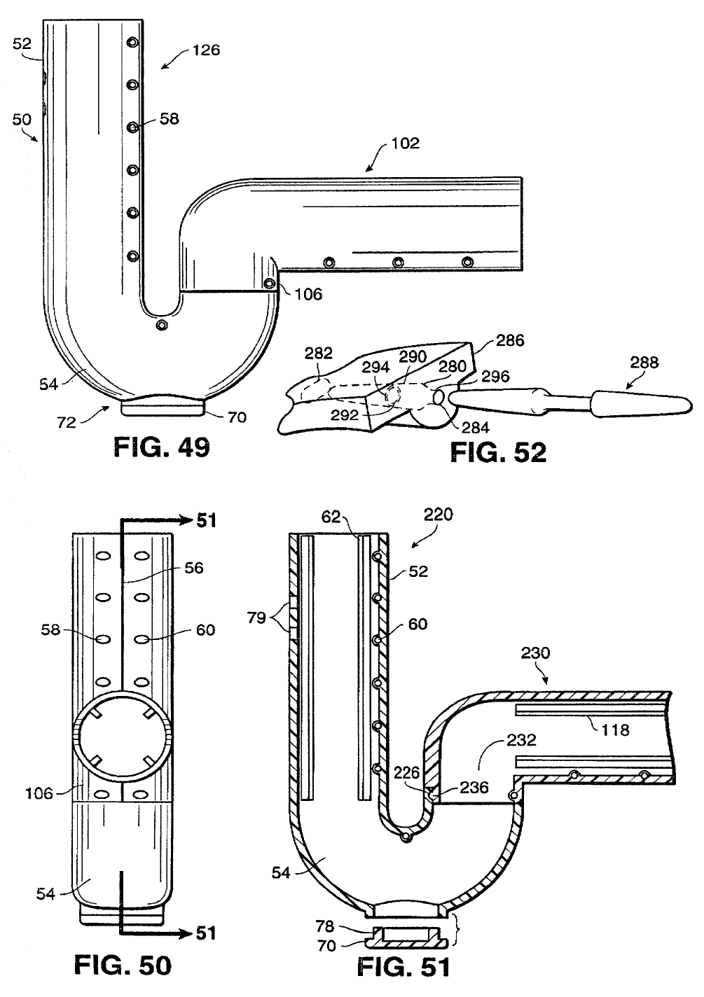

In accordance with this embodiment of the invention, a combination of the J-shaped jacket 220 and an L-shaped jacket 230, as best shown in FIGS. 49-51, are secured to one another. In this case, the L-shaped jacket has a stub end 232 which fits within the open end 222 and is snugly retained therein. The stub end 232 is provided with a outwardly flaring annular flange 236 and which snugly fits within the groove 226. In this way, the L-shaped jacket 230 will become coupled to the open end 222 of the J-shaped jacket 220.

The remaining portions of the details of construction of the J-shaped jacket 220 are substantially identical to that J-shaped jacket illustrated in FIG. 1 of the drawings.

It is important to note, however, in connection with the present invention, that the combination of the L-shaped jacket and the J-shaped jacket nevertheless provides a generally smooth and continuous outer appearance. Moreover, both jackets appear as though they generally have the same diametrical size. In this embodiment as shown in FIGS. 49-51, the J-shaped jacket may be slightly enlarged at the open end 222. In like manner, the stub end 232 of the L-shaped jacket 230 may be slightly reduced in diameter so as to fit within the open upper end 222. However, when the two components are fitted together, this slight enlargement of one portion and the slight reduction in size of another portion is not readily visible and the overall affect is that the two jackets are generally continuous in construction.

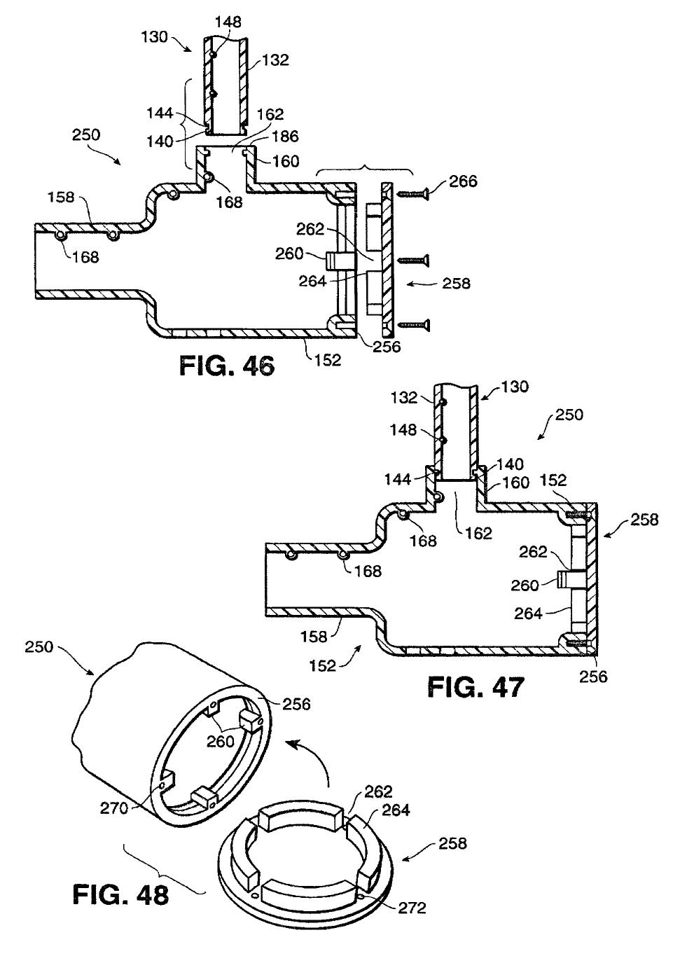

FIG. 46-48 illustrate a modified form of valve or elbow receiving jacket 250. In this case, the jacket 250 is similar in construction to the previously described jacket 150. However, in this embodiment, the side wall 152 is provided with a lower end 256 having a different removable bottom cap 258. In this case, the inner wall of the lower end 152 of the jacket 250 is provided with four inwardly projected indexing bosses 260 and which are located to receive grooves 262 located between four upwardly projecting arcuate flanges 264. In this way, the installer can easily rotate the bottom cap 258 until the grooves 262 become aligned with the projections 260, at which point the bottom cap 258 can be pushed upwardly into the lower end of the housing 250. This construction is best shown in FIGS. 47 and 48 of the drawings. Moreover, the bottom cap 258 can be suitably retained in its position over the lower end of the jacket by means of set screws 266. The inwardly struck projections 260 are also provided with screw holes 270 in order receive the sets screws 266 and which also extend through aligned openings 272 in the bottom cap 258.

FIG. 52 illustrates yet another modified form of fastener receiving housing 280 communicating with an inlet aperture 282 on the surface of a jacket and an aperture 284 which would communicate with a corresponding aperture in an opposite side of a jacket at a slit line 286. In this case, the inlet aperture 282 would receive a locking pin 288 substantially identical to the previously described locking pin 92, as shown in FIG. 45. The inlet aperture 282 leads to a channel 290 which has an outwardly diverging side wall. Located intermediately in the channel is a reduced diameter restriction 292 presenting an abutment surface 294. Thus, when a pin is inserted in the inlet aperture 282, the pin abuts against the abutment shoulder 294 and the remaining portion protrudes through a reduced diameter section 296 to the outlet aperture 284. This type of construction has also been found to be very effective in the present invention.

Thus, there has been illustrated and described a unique and novel heat protective cover system for hot water pipes and thereby fulfills all of the objects and advantages which have been sought. It should be understood that many changes, modifications, variations and other uses and applications which will become apparent to those skilled in the art after considering the specification and the accompanying drawings. Therefore, any and all such changes, modifications, variations and other uses and applications which do not depart from the spirit and scope of the invention are deemed to be covered by the invention.

Having thus described the invention, what I desire to claim and secure by Letters Patent is:

1 A heat protective cover for hot water pipes adapted to extend about a hot water pipe arrangement and cover substantial portions of that hot water pipe arrangement, said heat protective cover comprising:
a) a jacket having heat insulating qualities with a configuration similar to that of the pipe arrangement about which the jacket is to extend;
b) an elongate split formed in said jacket allowing said jacket to be opened at said split and extend about a hot water pipe;
c) apertures formed in portions of the jacket adjacent both sides of said slit for releasably receiving a fastener in each set of apertures to thereby lockably hold the jacket onto the hot water pipe arrangement;
d) pair of fastener receiving lock housings located at said elongate split with one of the lock housings of each pair on one side of said slit and the other of each pair on the opposite side of the slit, said lock housings on each side of said slit communicating with separate apertures, such that each aperture on one side of said slit is in direct alignment with an associated aperture on the opposite side of said slit and receiving a locking fastener in a releasable locking relationship when inserted into the associated apertures; and
e) a locking element in each said lock housing and being constructed to receive a specified type of locking fastener and to hold the fastener releasably locked in said lock housing.

2 The heat protective cover for hot water pipes of claim 1 further characterized in that said locking fasteners are also reusable so that after the jacket or a portion of the jacket has been removed from the pipe arrangement, said locking fasteners can be completely reinserted in said apertures and into said lock housings and hold the jacket onto the hot water pipe arrangement.

3 The heat protective cover for hot water pipes of claim 1 further characterized in that said fasteners are screws and that said locking elements of each pair is adapted to receive the shank of one of said screws.

4 The heat protective cover for hot water pipes of claim 3 further characterized in that said pair of apertures are located on a curved portion of said jacket and said apertures have elliptically shaped openings.

5 The heat protective cover for hot water pipes of claim 2 further characterized in that the shank of locking fastener in a pair of apertures and associated locking elements can be removed from one of the apertures and locking elements of the pair and retentively held in the other aperture and locking element of the pair thereby precluding loss of the locking element.

6 The heat protective cover f or hot water pipes of claim 5 further characterized in that said locking fastener is a screw having a threaded shank.

7 The heat protective cover for hot water pipes of claim 5 further characterized in that said locking fastener is a pin having enlarged ends which are tapered outwardly providing individually facing opposed locking shoulders.

8 The heat protective cover for hot water pipes of claim 5 further characterized in that said apertures and locking elements are each adapted to receive at least two different types of locking fasteners.

9 A heat protective cover for hot water pipes adapted to extend about a hot water pipe arrangement and cover substantial portions of that hot water pipe arrangement, said heat protective cover comprising:
a) a jacket having heat insulating qualities with a configuration similar to that of the pipe arrangement about which the jacket is to extend;
b) an elongate split formed in said jacket allowing said jacket to be opened at said split and extend about a hot water pipe;
c) apertures formed in portions of the jacket adjacent both sides of said slit for releasably receiving a fastener in each set of apertures to thereby lockably hold the jacket onto the hot water pipe arrangement; and
d) pair of fastener receiving lock housings located at said elongate split with one of the lock housings of each pair on one side of said slit and the other of each pair on the opposite side of the slit, said lock housings on each side of said slit communicating with separate apertures, such that each aperture on one side of said slit is in direct alignment with an associated aperture on the opposite side of said slit and receiving a locking fastener in a releasable locking relationship when inserted into that aperture, said apertures and associated lock housing being arranged to receive at least two different types of locking fasteners which have different locking actions.

10 The heat protective cover for hot water pipes of claim 9 further characterized in that said locking fastener is a pin having enlarged ends which are tapered outwardly providing individually facing opposed locking shoulders.

11 The heat protective cover for hot water pipes of claim 9 further characterized in that said locking fastener is a pin having enlarged ends which are tapered outwardly providing individually facing opposed locking shoulders.

12 The heat protective cover for hot water pipes of claim 9 further characterized in that said pair of apertures are located on a curved portion of said jacket and said apertures have elliptically shaped openings.

13 A heat protective cover for hot water pipes adapted to extend about a hot water pipe arrangement and cover substantial portions of that hot water pipe arrangement, said heat protective cover comprising:
a) a jacket having heat insulating qualities with a configuration similar to that of the pipe arrangement about which the jacket is to extend;
b) an elongate split formed in said jacket allowing said jacket to be opened at said split and extend about a hot water pipe;
c) apertures formed in portions of the jacket adjacent both sides of said slit forming sets thereof for releasably receiving a fastener in each set of apertures to thereby lockably hold the jacket onto the hot water pipe arrangement;
d) elongate fasteners sized for insertion into each of said apertures of a pair to lockably hold the portions of the jacket on both sides of said slit together, said fasteners comprising a shank and an enlarged end section at the end thereof; and
e) the material surrounding said apertures being sufficiently yieldable so that the enlarged end section fits within the aperture and essentially filling said aperture thereby reducing the possibility of engagement by a tool and unauthorized removal thereof.

14 The heat protective cover for hot water pipes of claim 13 further characterized in that said enlarged end section is a head of a screw and the shank is a threaded shank of that screw and the head fits within that aperture tightly to fill up the aperture.

15 The heat protective cover for hot water pipes of claim 14 further characterized in that said head is an Allens head requiring an Allens head tool to enable removal thereof.

16 The heat protective cove for hot water pipes of claim 13 further characterized in that said fastener is a pin having a pair of opposite enlarged end sections.

17 A heat protective cover for hot water pipes adapted to extend about a hot water pipe arrangement and cover substantial portions of that hot water pipe arrangement, said heat protective cover comprising:
a) a jacket having heat insulating qualities with a configuration similar to that of the pipe arrangement about which the jacket is to extend;
b) pair of fastener receiving lock housings located at said elongate split with one of the lock housings of each pair on one side of said slit and the other of each pair on the opposite side of the slit, said lock housings on each side of said slit communicating with separate apertures, such that each aperture on one side of said slit is direct alignment with an associated aperture on the opposite side of said slit and receiving a locking fastener in a releasable locking relationship when inserted into that aperture;
c) a locking element in each said lock housing and being constructed to receive a specified type of locking fastener and to positively hold and lock the fastener in a releasably locked position in said locking housing; and
d) a fastener inserted into one of said pairs of apertures and having an elongate shank engaged in and releasably held in said locking element.

18 The heat protective cover of claim 17 further characterized in that said locking element comprises an elongate channel therein and a pair of recesses in said channel adapted to receive a porion of said shank and hold same.

19 The heat protective cover of claim 18 further characterized in that said fastener is a pin having a pair of enlarged ends providing inwardly facing opposed shoulders which engage said recesses.

20 The heat protective cover of claim 18 further characterized in that said fastener is a screw and the portion of the shank engaged and held is threads on the shank of the fastener.

21 The heat protective cover of claim 18 further characterized in that said apertures and locking elements are each adapted to receive at least two different types of locking fasteners.

22 A heat protective cover system for hot water pipes comprised of a plurality of jackets which are capable of being coupled together to cover hot water pipes of a particular configuration, said heat protective cover system comprising:
a) a first jacket capable of being wrapped about a portion of a pipe configuration, said first jacket having an end section which provides a socket;
b) a second jacket also capable of being wrapped about another adjacent portion of the pipe configuration, the second jacket having an end portion which is sized to snugly fit within the socket of said first jacket;
c) an abutment flange formed on the inner end of said first jacket and being located to receive and engage an end of the second jacket; and
d) fastener receiving apertures on said first jacket for receiving fasteners and which will thereby further lock said second jacket to said first jacket.

23 The heat protective cover system for hot water pipes of claim 22 further characterized in that said abutment flange is located close to an open end of said first jacket and forms a receiving space from said open end to said abutment flange for receiving an end of the second jacket.

24 The heat protective cover system for hot water pipes of claim 22 further characterized in that both of said jackets have longitudinal slits to be wrapped about pipe sections they are designed to cover.

25 The heat protective cover system for hot water pipes of claim 24 further characterized in that each of said jackets have pairs of aligned apertures on opposite sides of said slit to receive fasteners and thereby lock the jackets on the pipe sections they are designed to cover.

26 The heat protective cover system for hot water pipes of claim 22 further characterized in that said socket first jacket has adjacent the end thereof one of an inner protuberance or a recess and the second jacket has the other of the protuberance or the recess, such that the protuberances fits within the recesses.

27 The heat protective cover system for hot water pipes of claim 22 further characterized in that said protuberances and recess are both circular in shape.

28 A heat protective cover system for hot water pipes comprised of a plurality of jackets which are capable of being coupled together to cover hot water pipes of a particular configuration, said heat protective cover system comprising:
a) a first jacket capable of being wrapped about a portion of a pipe configuration, said first jacket having an end section which provides a socket;
b) a second jacket also capable of being wrapped about another adjacent portion of the pipe configuration, the second jacket having an end portion which is sized to snugly fit within the socket of said first jacket; and
c) said first jacket having a portion which is tapered toward said socket and said second jacket has a portion thereof tapered toward the end which fits within the socket, the taper of one of said jackets being an outward or diverging taper, such that the end is enlarged and the taper of the other of the jackets being an inward or converging taper, such that when the end of the second jacket is fitted within the socket, the overall appearance of the jackets is that they have an essentially uniform diameter throughout and one is an extension of the other.

29 The heat protective cover system for hot water pipes of claim 28 further characterized in that the end of the first jacket is tapered outwardly and the end of the second jacket to be received at the socket is tapered inwardly.

30 The heat protective cover system for hot water pipes of claim 29 further characterized in that the degree of taper on the first jacket is approximately the same as the degree of taper on the second jacket.

31 A protective jacket for disposition around a pipe carrying hot water to prevent contact with and potential for burn injury, said jacket comprising:
a) a jacket having an outer wall formed of a flexible and bendable material capable of being wrapped about a portion of the pipe, said wall having a length extending about a portion of the length of the pipe;
b) a slit in said jacket allowing said wall to be opened and fit about a pipe with the resiliency of the material allowing the portion of the jacket at said slit to come back together; and
c) fins located at an inner surface of said pipe and projecting inwardly to engage a pipe or component secured to the pipe and which fins are longitudinally arranged in said wall of the jacket.

32 The protective jacket for disposition around a pipe carrying hot water of claim 31 further characterized in that said fins are also formed of a flexible and bendable material so that they will deflect to accommodate a pipe or component on the pipe.

33 The protective jacket for disposition around a pipe carrying hot water of claim 32 further characterized in that said fins are formed of a material which also has sufficient rigidity to hold the weight of the jacket on a vertical section of pipe through frictional engagement with the pipe and/or a component on the pipe.

34 The protective jacket for disposition around a pipe carrying hot water of claim 32 further characterized in that apertures formed in portions of the jacket adjacent both sides of said slit for releasably receiving a fastener in each set of apertures to thereby lockably hold the jacket onto the hot water pipe arrangement.

35 The protective jacket for disposition around a pipe carrying hot water of claim 34 further characterized in that pairs of fastener receiving lock housings are located at said elongate split with one of the lock housings of each pair on one side of said slit and the other of each pair on the opposite side of the slit, said lock housings on each side of said slit communicating with separate apertures, such that each aperture on one side of said slit is in direct alignment with an associated aperture on the opposite side of said slit and receiving a locking fastener in a releasable locking relationship when inserted into the associated apertures

36 A fastener for use heat protective covers of the type disposed over hot water pipes and which have an elongate slit allowing jacket sections to be spread apart and enveloply cover a pipe section, said fastener comprising:
a) an elongate shank;
b) a pair of enlarged ends at each of the opposite ends of said shank; and
c) a shoulder abutment surface facing inwardly on each of the enlarge ends and being sized and located to engage shoulders in apertures of each of the jacket sections.

37 The fastener of claim 36 further characterized in that said enlarged ends have outwardly tapering surfaces.

38 The fastener of claim 37 further characterized in that said outwardly tapering surfaces terminate in rounded ends and which ends are sized sufficient to fill an aperture in which they are inserted.
